(19) United States
(12) Patent Application Publication
(10) Pub. No.: US 2026/0074895 A1
(43) Pub. Date: Mar. 12, 2026

(54) DECENTRALIZED SENSITIVE INFORMATION SHARING

(71) Applicant: Secret Shield Inc., Denver, CO (US)

(72) Inventor: David Brett Pasirstein, Denver, CO (US)

(21) Appl. No.: 19/312,020

(22) Filed: Aug. 27, 2025

Related U.S. Application Data
(60) Provisional application No. 63/691,978, filed on Sep. 6, 2024.

(51) Int. Cl. H04L 9/08

(52) U.S. Cl. CPC H04L 9/085; H04L 9/0891

(57) ABSTRACT

An asynchronous system enables a secret (digital data) to be decentralized by deriving and distributing shares among a set of guardian computing systems such that the secret can be reconstructed by a consensus of the guardian computing systems. Communications between the secret owner's computing system and the guardian computing systems are subject to a communication protocol under which at least some of the messages include encryption protocol data that operates to coordinate key updates for securing subsequently transmitted messages. Additionally, the system provides mechanisms to verify possession of the shares by the guardian computing systems and potentially redistribute the shares.

### CROSS-REFERENCE TO RELATED APPLICATIONS

This application claims the benefit of U.S. Provisional Patent Application No. 63/691,978 filed on Sep. 6, 2024, which is incorporated by reference herein.

### BACKGROUND

### Technical Field

The present disclosure relates to the field of information security, cryptography, escrow, data recovery, and more particularly to methods and systems for decentralized secret sharing and recovery.

### Description of the Related Art

Secret sharing is a computer-based cryptographic method for sharing a secret (e.g., any digital computer-readable data) among a group of participants (e.g., a set of computer storage devices) such as a quorum such that a subset of the quorum can be defined as the threshold necessary for agreement to reconstruct the original secret. This can be useful for a variety of applications, such as protecting sensitive data or ensuring that a decision can only be made with the agreement of multiple parties.

One common method of secret sharing is Shamir Secret Sharing (SSS). In Shamir secret sharing, the secret is processed into a number of shares, that ideally do not contain the original secret. The shares are then distributed to the participants. To reconstruct the secret, a certain number of shares (the threshold) must be combined.

Conventional secret sharing schemes have many limitations. One limitation is that conventional secret sharing schemes require trust in the participants. There are multiple facets to this limitation. For example, in Shamir secret sharing, the participants must be trusted not to collude to reconstruct the secret without the cooperation of the other participants. Another is they must be trusted to keep the secret in their possession, not lose it, not collude with each other, and to provide the correct shares when needed. Some services resort to a known trusted set of guardians to facilitate holding and later returning the shares. The size in bytes of the shares can be prohibitively large in many implementations such as those using QR codes. Other limitations include storing larger data encrypted to a known location or centrally while distributing only the decryption key amount to the participants, thus leaving the data itself subject to brute-force attacks from anybody who can gain access to the known location. And yet another is that they must have a way to distribute and later collect the shares securely which sometimes results in secure distribution or recovery either requiring in-person/face-to-face interactions or other less integrated mechanisms to attempt to secure the transmission of the share data. Guardians may misplace, lose, or otherwise no longer have access to the shares resulting at best in fewer actual guardians available for recovery or at worst, a case where the secret is lost and cannot be recovered. If it were determined that the secret should be unshared such that it should not be recovered, there is no clear way to confirm that the secret can no longer be recovered. If a guardian is a malicious actor, they may intentionally provide at least 1 incorrect share to which the invalid share is not detectable, and it would prevent a successful recovery.

### BRIEF DESCRIPTIONS OF THE DRAWINGS

The disclosed embodiments have advantages and features that will be more readily apparent from the detailed description, the appended claims, and the accompanying figures (or drawings). A brief introduction to the figures is below.

FIG. 1 illustrates an asynchronous method for the decentralized sensitive information sharing to negotiate a common key and negotiate an initialization for future encrypted communication, according to one embodiment.

FIG. 2 illustrates an asynchronous distribution of sensitive information while providing for an optional rotation of keys without regard for the communication medium, according to one embodiment.

FIG. 3 illustrates an asynchronous status verification of the distributed sensitive information while providing for an optional rotation of keys without regard for the communication medium, according to one embodiment.

FIG. 4 illustrates an asynchronous synchronization of the secret configuration (distribution, threshold, etc.) while providing for an optional rotation of keys without regard for the communication medium, according to one embodiment.

FIG. 5 is a block diagram illustrating components of an example machine able to read instructions from a machine-readable medium and execute them in a processor (or controller), according to one embodiment.

FIG. 6 illustrates an example networked computing environment in which decentralized sensitive information sharing with data may be provided, according to one embodiment.

FIG. 7 illustrates a generalized overview of secret sharing by issuing shares and returning a subset used for reconstruction.

FIG. 8 is an example embodiment of a process for implementing decentralized secret sharing and reconstruction.

### DETAILED DESCRIPTION

The present embodiments provide a method and system for decentralized secret sharing that overcomes the limitations of conventional secret sharing schemes. The present embodiments are decentralized, meaning that the secret is not stored in a single location. This makes the secret more secure against attack. The present embodiments also do not require a significant level of trust in the participants. This is because the design makes the distribution seamless on a global scale through an electronic medium without the need for guardians (participants assigned to hold shares) to be aware of each other.

In one embodiment, a method for decentralized secret sharing is provided. The method includes the following steps of:
Generating a secret (e.g., computer-readable data);
Dividing the secret into a plurality of shares;
Selecting guardian participants (e.g., computer storage devices) from a set of known established contacts
Distributing the shares (e.g., via a network) to a plurality of participants;
Verifying that the participants still hold the shares assigned to them and have not lost it; and
Reconstructing the secret from a subset of the shares.

In another embodiment, a system for decentralized secret sharing is provided. The system includes a verifier mechanism to alert the secret owner (e.g., via an electronic notification on a device associated with the owner) that a guardian participant no longer holds the shares and the ability for the share distributor (e.g., a module of an application executable on a computer device) to redistribute the secret to maintain the integrity for a future recovery/reconstruction. The share distributor divides the secret into a plurality of shares and distributes the shares (e.g., via network) to a plurality of participants. The verifier (e.g., a module of an application executable on a computer device) verifies that the participants still hold the shares assigned to them and have not lost the shares.

The present embodiments provide numerous technical improvements over conventional secret sharing schemes. These technical improvements include, for example:
Decentralized secret sharing: The secret is not stored in a single location, even larger amounts of data, making it more secure against attack.
Little to no trust in participants: Since participants do not know about each other, the number of shares, or the threshold required for reconstruction, the risk of collusion is significantly reduced or eliminated.
Scalability: The present embodiments can be easily scaled to support a large number of participants with the secret holder in control of who the guardian participants are for a given secret. The present embodiments can support variable sizes of data.
Reliability: The present embodiments can confirm that a guardian participant is still in possession of their shares, may notify the secret owner if the guardian no longer has possession of the shares, and may re-distribute the secret shares to ensure the dimensions of the distribution (such as the number of guardians with valid shares and availability to participate in recovery) is maintained.
Data Security: The present embodiments may protect the data both in transit such as for distribution and recovery as well as at rest, such as in the possession of the guardians.
Hostile Resistance: The present embodiments may determine the return of incorrect or invalid shares protecting from accidental and malicious intent to block a successful recovery.
Flexibility: The present embodiments can be adapted to a variety of applications.

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Shamir Secret Sharing (SSS) is an efficient secret sharing algorithm for distributing private information (the “secret”) among a group so that the secret cannot be revealed unless a quorum of the group acts together to pool their knowledge. It applies the Lagrange interpolation theorem to each share or to each byte in each share to determine a polynomial that can be used to calculate the corresponding data point. In this context, a secret is any data such as text, binary, document, or file to which SSS is applied.

While there are practical uses for this today, there are also variations to create fit-for-purpose solutions to address some of the complexities that arise from practical applications to real-world uses.

Many complexities arise in both trust and technical limitations. For example, some of the complexities with trust include: trusting the participants to not collude, trusting the distribution or collection is not compromised, trusting that the data at rest with the participants is secure, and trusting the participant has not lost the data. Some examples of technical complexities include data size such as the number of bytes restricting distribution and collection, advanced knowledge of participants (person, entity, or machine), privacy, and private communication between the secret creator/owner and participants, the dependence connected to the distribution/collection communication medium. Those complexities in trust and technical are in the normal correct use.

To complicate matters further, the processes may be attacked by malicious or threat actors seeking to either steal the secret or block the recovery of the secret. Some examples of such points of attack may occur by, attempting to steal the data in transit (distribution or collection), attempting to steal the data at rest either by way of compromised system access, by a system left open, a disposed system containing the data, or by simply requesting it from a guardian. Other attacks such as those to prevent or block recovery include attempting to corrupt the data either in transit or at rest in the possession of a participant that exploits the lack of verifiability in the shares when used for the reconstruction of the data.

SSS is also recognized for its limitation in having a single point of failure in that the secret must exist as a whole at the point of splitting into shares and at the point of reconstruction. However, the described embodiments disclosed within exploit this as a feature of the solution.

Although the described embodiments address the identified complexities and risks and this disclosure focuses on SSS, the described embodiments are not limited to or constrained to SSS. Alternative methods that may or may not be secret sharing may replace or be used in conjunction with SSS.

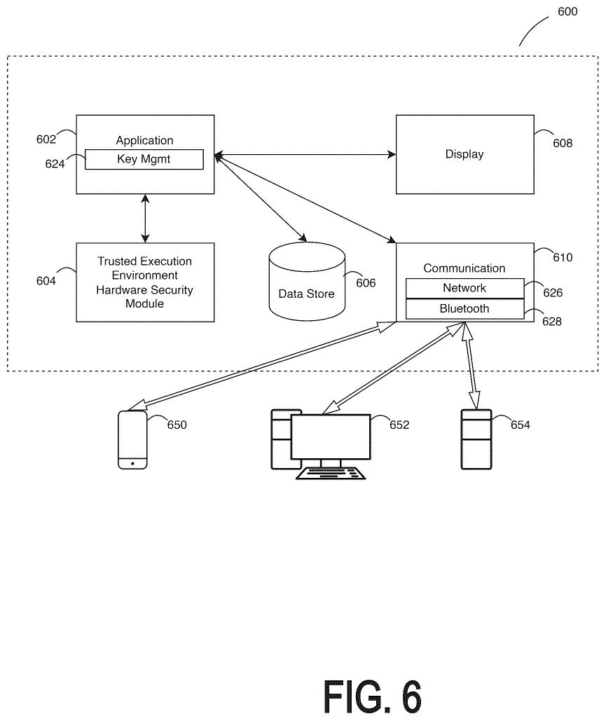

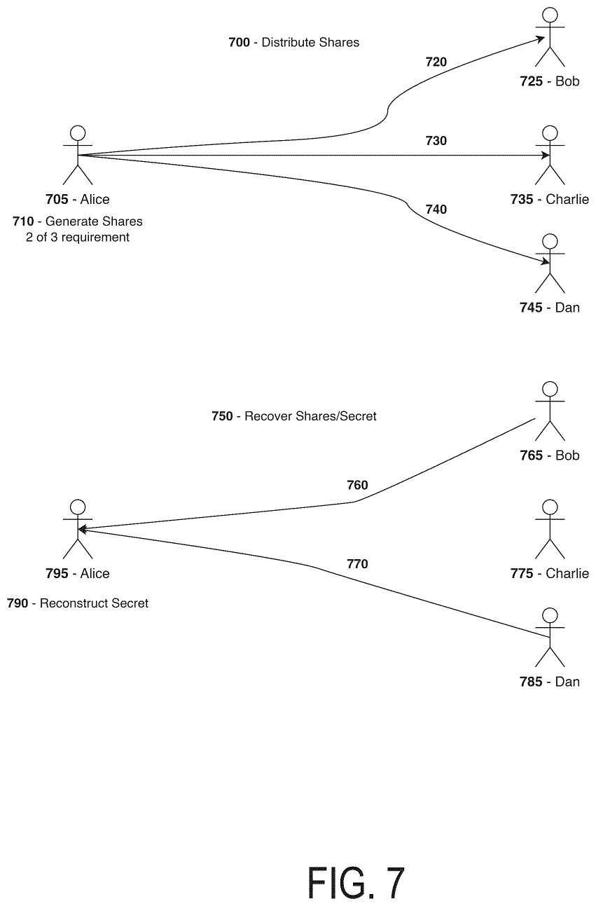

FIG. 7 is a diagram of a system for decentralized secret sharing according to one embodiment, described in combination with the architecture of FIG. 6. In one example embodiment, each actor or participant 705, 725, 735, 745, 765, 775, 785, 795 may be represented respectfully by the diagram in FIG. 6, where each could be a mobile device 650, or computer 652, 654 with example functional capabilities 600. Disclosed by way of example embodiment is a configuration that may include a method (and/or corresponding system and computer-readable medium storing instructions in a data store 606 executable by one or more processors 602, 604, 624) for taking information such as a secret and decentralizing it among a set of participants 720, 730, 740 such that consensus threshold must be met to reconstruct 790 the original secret without the trust of an individual while limiting collusion, without accepting a high risk of trust of the participants, and while providing protections from malicious threat actors.

In this configuration, a secret holder 705 may identify some number of entities addresses to which will be target participants to hold issued shares (guardians) 725, 735, 745. In this embodiment, the guardian participants may be known to the secret holder by way of a shared or local directory or address/contact list, data store, or unique identification. In most common scenarios, although not required, the secret holder has a pre-existing relationship with the participants such that the participants have authorized the secret holder to address them as guardians and/or authorized the receiving of shares from the secret holder as part of the distribution to decentralize the shares. Such a directory does not require personally identifiable information and instead can contain randomized identifiers that can be used to address individual devices as a factor in preserving privacy.

In an alternate embodiment, a guardian may choose to allow any secret holder to issue shares to them without requiring a pre-existing relationship.

The distribution of the shares may be done securely to protect the information in communication transit 610. The guardian participant may also store the information in a highly secure medium 604, 606, such that they have timely access to it when required while protecting it from malicious actors.

Although, with SSS, any quorum of guardian participants may get together and recover the secret, in this embodiment, the guardians may not know about each other, they may not know the number of shares issued, and may not know the threshold required for reconstruction. (i.e., this information is not electronically distributed to the participant devices and the owners of such devices do not have direct access to such information). In such a scenario, the original secret holder that distributed the shares is now the secret owner 795 and the only person with the required knowledge (either direct knowledge or by virtue of information stored to or accessible by the secret owner's device 602, 608) to obtain the shares and reconstruct the original secret 790. In an alternate embodiment, the secret owner may share this required knowledge with one or more additional trusted entities that may or may not be guardian participants.

As implemented on machine architectures that may include computers and mobile phones, the communication may be encrypted. Common cloud and software-as-a-service implementations sit in the middle to facilitate transactions between parties by offering TLS communication that encrypts the communication from the secret holder/owner machine architecture to the cloud service in the middle and then separately encrypts from that point to each guardian participant's respective machine architecture. There are several limitations in this computer network communication architecture, for example, the computer or network architecture in the middle could be directly compromised by a malicious actor gaining access to those components or by way of a man-in-the-middle attack on the communication itself by either a rogue/malicious actor with access to a trusted certificate or government/corporate communication surveillance proxy with dynamically issued trusted certificates. Fundamentally, the TLS is based on trust of the certificates and while certificate pinning could address a rogue man-in-the-middle attack, it would not sufficiently address the former and fail when used on corporate proxies that issue dynamic certificates for communication inspection. TLS or similar approaches may nevertheless be employed in conjunction with other features described herein that remedy shortcomings of TLS alone. TLS is a well-established standard and provides simplicity in that each participant's execution environment only needs to trust the service in the middle.

An alternate embodiment includes applying a process to process-level encryption such as the Double Ratchet algorithm or PQXDH (“Post-Quantum Extended Diffie-Hellman”) to the communication. This implementation may include a predecessor step to establishing Double Ratchet-based communication that involves establishing an initial shared secret that is then used as part of the overall key negotiation. This can be achieved through a Diffie-Hellman key exchange (DH), ML-KEM, or an Elliptic Curve Diffie-Hellman key exchange (ECDH) and alternately, through two people such as a face-to-face interaction deciding together on a shared secret. This step can occur at the point of establishing the initial shared secret or at the point of initializing the double ratchet communication between the parties.

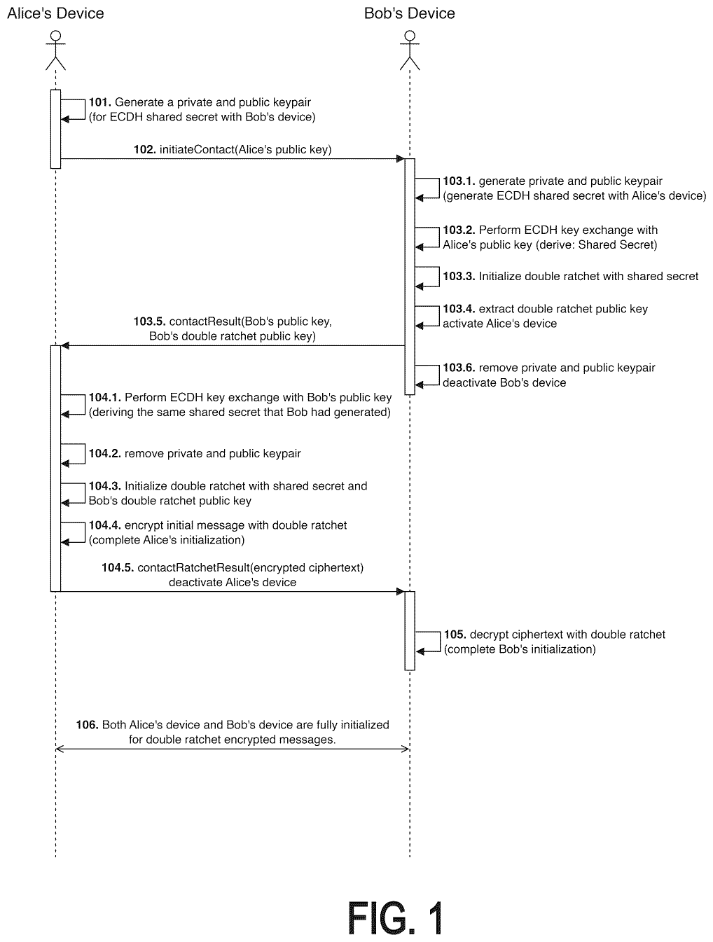

FIG. 1 describes such an embodiment for a standard ECDH key exchange used to establish a shared secret with an optimized/integrated double ratchet initialization. The first step is for participant 1, we will call “Alice”, to generate private and public material 101 and send the public component to participant 2 that we will call “Bob” 102. Then Bob will generate their own public and private material 103.1, use Alice's public component to generate a shared secret 103.2, immediately use that data to start the double ratchet initialization 103.3, and extract and transmit the public material 103.4 to send back to Alice 103.5. Bob's public private key material is no longer required 103.6. Alice will use Bob's initial public material to generate the same shared secret 104.1, then use Bob's double ratchet public material to initialize Alice's side of the double ratchet 104.3 and then use the initialized double ratchet to generate a first message 104.4 to send to Bob 104.5. Alice's public and private material are no longer required 104.2. Bob will use his double ratchet to decrypt Alice's message 105 thus completing the double ratchet initialization. At this point, both Alice and Bob can freely send double ratchet encrypted messages 106.

Key negotiation may be implemented using standard techniques, or may optionally include an additional step to allow any prospective participant (secret owner or guardian) to approve or decline a request to participate thus allowing or blocking the key negotiation. In such an alternate embodiment, when Alice sends the public material to Bob 102, it could also contain an optional message and before Bob moves forward with the next step 103.1 Bob's device may prompt Bob to confirm to proceed and optionally display the message. Another alternative may be to allow all the steps up to and including completing Bob's double ratchet initialization 105 to proceed for to then send the optional message then prompting Bob to accept before saving the result of the negotiation and allowing Alice and Bob to freely exchange double ratchet encrypted messages 106. Key negotiation or renegotiation may occur at initialization and optionally any point as required by a participant.

Encrypting-to-process also has an additional benefit over device-to-device VPNs in that it can limit exposure to compromises in machine architecture such as a virus. This is because the ingress or egress is fully encrypted which would not be the case with BLUETOOTH pairing or other protocols relying on the operating system or device firmware to encrypt the communication. It also does not prevent the ability for TLS, VPNs, firmware, or other machine-level encryption to be applied. For example, all the steps described for the key negotiation embodiment in paragraph [0032] FIG. 1 could occur with TLS, VPNs, and other machine or network-level encryption applied.

Applying the Double Ratchet algorithm, Pretty Good Privacy (PGP), Off-the-Record messaging protocol (OTR), classic point-to-point encryption, or similar alternative between the processes has the benefit of reducing or eliminating trust in the medium of communication and reducing or eliminating trust in a middle-tier service if one exists. The Double Ratchet algorithm has the added benefit of rotating the keys and specifically when communication exists bi-directionally, it allows for the message key to be fully changed as opposed to derived which means that earlier keys cannot be calculated from later keys as well as preventing later keys from being calculated from earlier keys. However, this cannot be achieved by classic synchronous request-response or persistent network connections where the cryptography lies at the network layer. Instead, the described embodiments exploit this point by using asynchronous messaging such that distribution, distribution confirmations, shares status checks, recovery requests, and so forth can be independently encrypted allowing for continuous, on-demand, time-based, message count-based, or similar key rotation as part of the algorithm independent of the network channel. Key rotation implies the process of replacing an active cryptographic key with a new one. Some examples of key rotation include a new key that may be derived, computed, precalculated, or an unrelated replacement of a new value.

While the specific design operates independently of the network channel, this approach operates such that each message is encrypted with the keys negotiated for the target code execution process. The benefits of this when combined with the asynchronous confirmations, share status requests, share status results, and so forth protect against malicious threat actors in both attempting to use stolen data or attempting to corrupt the data to make it unrecoverable.

Thus, such a threat actor may be able to observe all the communication data but will be unable to exploit it. The embodiments therefore can provide security without relying on trust of the communication medium while ensuring participants are communicating with other known approved participants.

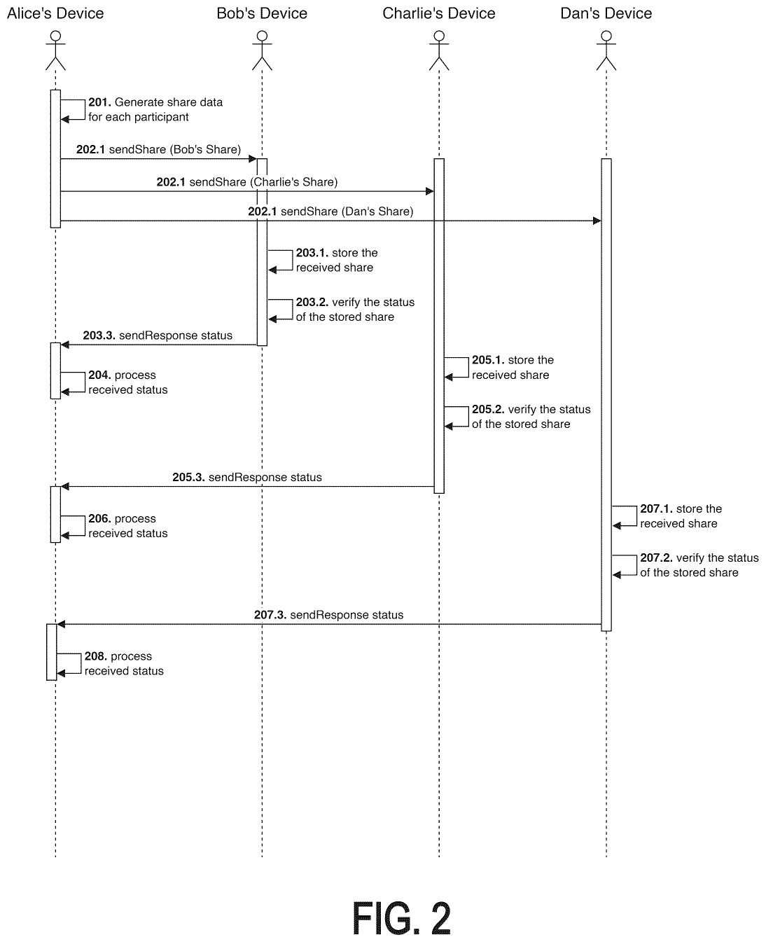

The asynchronous design of communication followed by confirmations for events such as distribution, share status, and collection for recovery serves multiple purposes and situations. FIG. 2 demonstrates an embodiment for data distribution to multiple parties. We will have four (4) participants: Alice, Bob, Charlie, and Dan each using a device respectively. Alice will take the secret and use it to generate shares 201 that will then be distributed to Bob 202.1, Charlie 202.2, and Dan 202.3. Bob, Charlie, and Dan will each respectively store that data 203.1, 205.1, 207.1, generate a confirmation 203.2, 205.2, 207.2, and send the confirmation as a status response back to Alice 203.3, 205.3, 207.3. The confirmation may be a simple indicator or may be more complex such as a proof to demonstrate the data has been received and is not corrupt.

Upon receiving the confirmation from Bob, Charlie, and Dan respectively and independently, Alice will process the result 204, 206, 208. Each time a message is sent to another's device 202. [1,2,3], 203.3, 205.3, and 207.3, the message is first decrypted using the key established for the specific sending device before processing; however, that message may also contain information that can be used to compute the next key to be used for the receiving device to encrypt communication messages back to the sending device. For example, this would occur between when Alice distributed the shares to Bob 202.1 and when Bob has received and beings processing the message from Alice 203.1. The response that Bob provides back to Alice (203.3) could contain additional material such as material pertaining to encryption key rotation that Alice could use for future communication with Bob. FIG. 2 also highlights the asynchronous approach: when Alice completes the send of shares to Bob, Charlie, and Dan 202.[1,2,3], the communication is complete. Similarly, when Bob, Charlie, and Dan respectively and independently send their response to Alice 203.3, 205.3, and 207.3, it represents net new communication messages. Time bounding between such messages is purely optional; however, under proper successful conditions, a message containing the response will be sent allowing for the key to be changed. Similarly, message retry or the resending of messages is also optional and possible.

For those familiar with the arts, this approach is distinct from TLS, commonly used with HTTPS, VPNs, SSH, and other similar protocols. In the case of TLS, VPNs, BLUETOOTH 628 pairing, and other tunneling or network layer communication 626 encryption, the request/response or asynchronous messages are tunneled inside the network layer encrypted channel. The channel may renegotiate key rotation per the respective protocol design; however, that occurs independently of the data communication passed. Similarly, the application sending data through the tunnel may have limited ability or control to determine when to re-negotiate a new key.

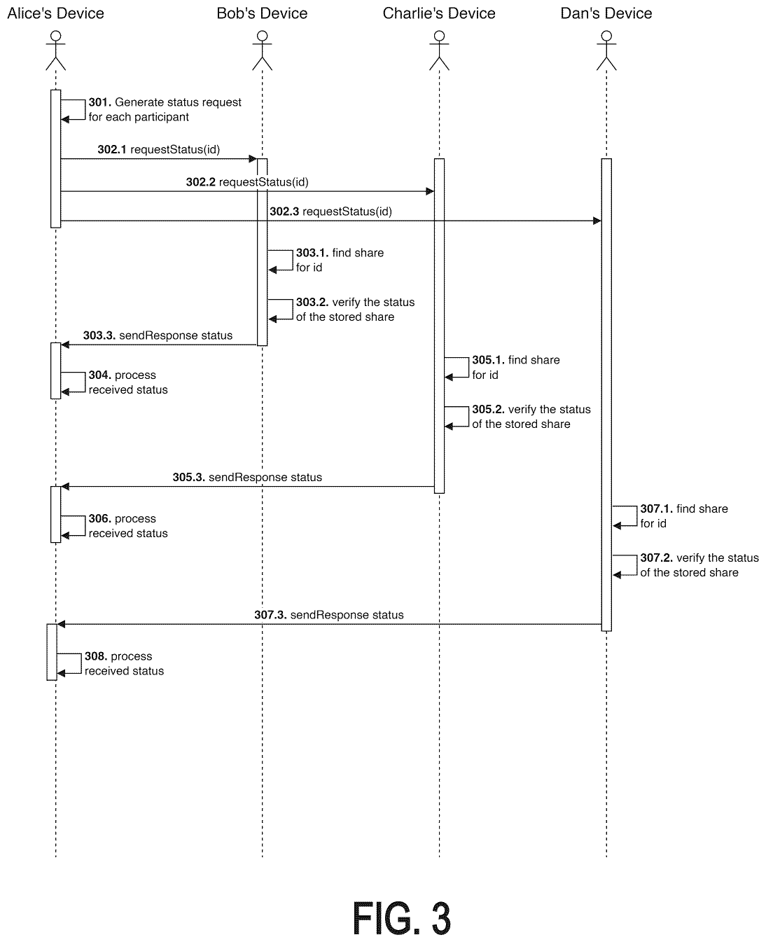

For example, if part of the medium for communication involves a messaging server on a network, the share status request sent by a secret owner to each guardian participant is to confirm that the guardian still holds the issued shares. Such an embodiment is demonstrated in FIG. 3.

We will have four (4) participants: Alice, Bob, Charlie, and Dan each using a device respectively. Alice will generate requests 301 to ask for a hash (some type of proof) of the shares previously stored by Bob, Charlie, and Dan. The hash or proof of a certain byte range in the shares, a merkle root, or some other information by which confirmation may be asserted. Alice will send that request to Bob 302.1, Charlie 302.2, and Dan 302.3. This embodiment also allows for privacy and protection of the secret in that it is not necessary to transmit any part of the secret in response to prove possession of it. Alice's requests 302.[1,2,3] may also contain material that could be used to encrypt a response message before being sent by Bob 303.3, Charlie 305.3, and Dan 307.3. In this case, Bob will decrypt the message from Alice 202.1, if applicable, process the material for the new key, and process the request by finding and verifying the stored share 303.1, 303.2. The Bob's results confirming or declining the retained presence of the shares are then sent as a response message back to Alice 303.3 which may be encrypted and include additional material for the next message to be sent Alice to Bob. Alice may use that response to process and verify the status 304. The same steps are respectively completed between Alice and Charlie 305.1, 305.2, 306 and between Alice and Dan 307.1, 307.2, 308. In this case, the asynchronous send addresses that the recipient may be offline or unreachable at that time. When they become reachable, they can process the status request and send the result to the secret owner which may be offline or unreachable then, and later receive the message when they are back online. If the medium were BLUETOOTH or the communication was synchronous, then all parties may need to be online; however, that is a limitation of the medium and not the message communication design of the disclosed embodiments. The disclosed embodiments exploit the key rotation of algorithms like double ratchet or alternatives through the message design in that response messages are expected for various communication requests. Therefore, each asynchronous sent event emits a net new message allowing for keys to continuously be rotated independent of the network or other communication medium.

The share status request may be automated such as on a schedule. In such an embodiment, the request from the secret owner's, in this case Alice's, execution system 302.1 and the processing and response back to Alice from the target guardian participant's, in this case, Bob's, execution system 303.[1,2,3] may be fully automated without requiring manual interaction in the successful case of confirmation. In the case that the participant's execution system returns a negative response to the request, then an alert can be raised to the secret owner with a variety of options such as redistributing the shares and protecting the recoverability of the secret. In addition, the automated schedule for the communication ensures the possibility of constant rotation of the encryption keys with each respective message communication between devices.

While sensitive information such as a secret may be distributed to other devices, the disclosed embodiments do not impose any requirement on the original owner, who distributed the initial information, stewardship of the original copy. Thus, the sensitive information owner can maintain a copy of the original secret and/or a record of the original secret such that the status request can confirm the validity of the response from the participant.

Positive and negative requests may also be used to track and calculate the availability of the shares to support a timely recovery. This may help optionally inform the sensitive information owner if a redistribution to include additional guardians may improve the likely timeliness of a recovery. It can also be used to determine availability to pay or otherwise incentivize guardian participants.

In an embodiment where the guardian participant stores the shares in an application on a mobile phone, such a status check is helpful in the event that the mobile phone could be lost, broken, or replaced with a new device that would not contain the shares and require a redistribution.

In one embodiment, the collective information including the number of shares issued, the threshold, and the guardian participants or the randomized identifiers used to address the guardian participant devices with record data that can be used to confirm the original secret may be stored as a secret configuration. This secret configuration does not need to contain the secret itself and combined with using the randomized identifiers, it can serve to protect privacy, and limit the impact if it were ever stolen while providing all the information for a secret owner to confirm the status of the shares with the guardian participants and enable the secret owner to issue a recovery request with the guardian participants.

In an embodiment, where this is a software application running on the respective mobile devices of the secret owner and guardian participants, the secret owner's configuration could be backed up to a cloud service. If the owner replaced their mobile phone, the configuration could be restored or imported to the new phone, thus providing a mechanism for the owner to continue to confirm the share status and/or recover the secret.

Such a secret configuration could also be shared with designated trustees such as another device, entity, or individual. By a trustee holding a copy of the secret configuration, they too could request recovery of the original owner's secret. Accordingly, the guardian participants would verify and approve the trustee's request, while the underlying communication would continue to offer the possibility of continuous key rotation.

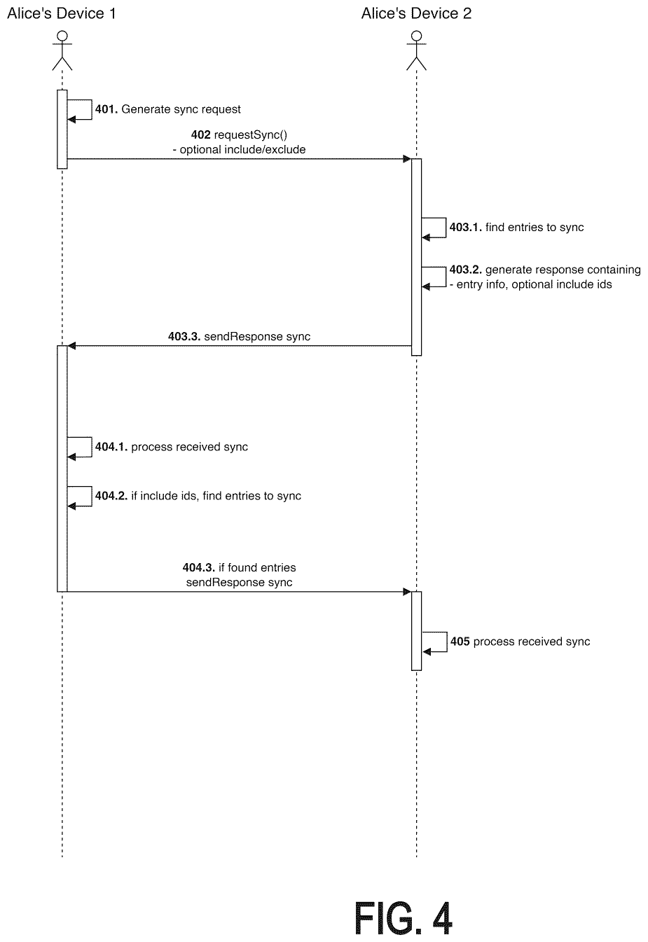

FIG. 4 demonstrates an embodiment for synchronizing such secret configurations in an asynchronous design. It assumes FIG. 1 Negotiation Flow may have already occurred between the devices. For this embodiment, Alice has 2 devices: device 1 and device 2. Device 1 will generate a request for the synchronization of configurations 401 and send that request message to device 2 402. The message may contain a list of secret configuration identifiers to exclude those it may already have. Per the disclosed design, this optionally asynchronous message (and all messages) going between device 1 and device 2 may contain material enabling the rotation of keys for subsequent messages. Device 2 will process the message by finding configurations to sync 403.1, it will produce a response message containing the secret configurations minus those excluded plus any secret configuration identifiers that it may request from device 1 403.2, and will transmit that response back to device 1 403.3. Upon device 1 receiving and processing that response 404.1, the exchange may be complete. Alternately, since the response from device 2 may contain secret configuration identifiers requested from device 1, then device 1 will try to find the configuration corresponding to the identifiers and add them to a response message 404.2. If such a message were populated, a response would be sent from device 1 to device 2 404.3 and device 2 would process the response 405 completing the exchange.

Suppose sensitive information, such as a secret, was decentralized to guardian participants. There is no need for those participants to know the existence of one another, nor is there a need for the participants to know the threshold required for recovery. That information would be only known by the secret owner, the secret configuration, and anybody or entity to whom the secret owner explicitly shared that information. While the privacy of the guardians may be preserved, there is a risk that if the secret configuration were stolen by a malicious actor, it could be used to initiate a recovery. However, the system may provide a mechanism to protect and mitigate this scenario. This could be mitigated in several ways. In the case of a computer or mobile application system using a key rotation mechanism such as Double Ratchet, the malicious actor may become approved by the guardian participants for any communication between each of their respective systems. Next, upon the malicious actor initiating a recovery, the system can request that each guardian participant confirm the identity of the requester by either manual (phone or video call), verification of a pre-agreed confirmation phrase, or automated mechanism. If the guardian participant were an automated system, it may request an identity verification such as a legal photo ID plus a liveness check before returning the shares for reconstruction of the secret.

Another embodiment for mitigation of a stolen secret configuration or collusion of the guardians could be to encrypt the data before generating or distributing the shares, then upon recovery and reconstruction, there could be an additional step to decrypt the data before it can be revealed.

In the disclosed implementation, it is highly unlikely to virtually impossible for a malicious actor to successfully achieve all the steps necessary, both technologically and human interactive steps, to steal a secret using the secret configuration.

The disclosed embodiments may furthermore enforce that the share data is protected at rest in the possession of a guardian participant. In an embodiment, where this is a software application running on the respective computer systems or mobile devices of the secret owner and guardian participants, use of Hardware Security Modules (HSM) and Trusted Execution Environment (TEE) could be used to encrypt the data at rest with local keys that may not be removed from the environment. For example, on a mobile device with such a TEE, the only way to decrypt the shares would be on that device with the keys locked in the TEE.

This embodiment would protect from a malicious actor such that even if the actor obtained the share data from a guardian participant's device, they would not be able to decrypt the data. If they were able to modify the data, the guardian participant would not be able to decrypt the data and thus it would be identified because it would fail status checks. If a malicious actor were to extract the data and either via an HSM/TEE flaw or brute force decrypt the share data, the risk would still be minimized. This is because 1) share data does not need to contain the secret, 2) the threshold of shares must be met to reconstruct the secret, and 3) the encryption keys used to store the respective data on each respective guardian participant device are different requiring each to be broken and cracked independently.

Similar to requesting share status, or requesting recovery to the guardian participants, an embodiment may also allow for the ability for a secret owner to request the removal (deletion) of the shares from the guardian participants. This can be done by using the secret configuration to send an encrypted message request with the specific instruction. The results of that request are returned to the secret owner in a confirmation message that would also allow for the continued encryption key rotation. The secret owner can track the number of outstanding unconfirmed shares and as such can know if the secret can still be recovered or if enough shares are deleted such that recovery would be impossible.

An embodiment may also optionally feature a “dead man's switch” such as automated removal of the distributed share data from a guardian participant's device given certain conditions. An example condition may be that no owner status checks of the shares had been received for a given period.

Although a guardian participant could maliciously respond to such a removal request with a confirmation while keeping the share data, several mitigating factors exist. First, given an embodiment with cryptographically signed application code, it is possible to verify that the response was generated truthfully according to the signed code. If the code had been tampered with to provide an incorrect response, then the signature would be invalid. For a malicious guardian participant to use the data, they would need to know the other guardian participants and for enough of those other guardian participants to do the same in maintaining a copy such as to collude and recover the secret. An embodiment may operate from the standpoint that this is highly unlikely to virtually impossible to successfully achieve all the steps necessary, both technologically and human interactive steps, to steal a secret by this mechanism.

### Example Machine Architecture

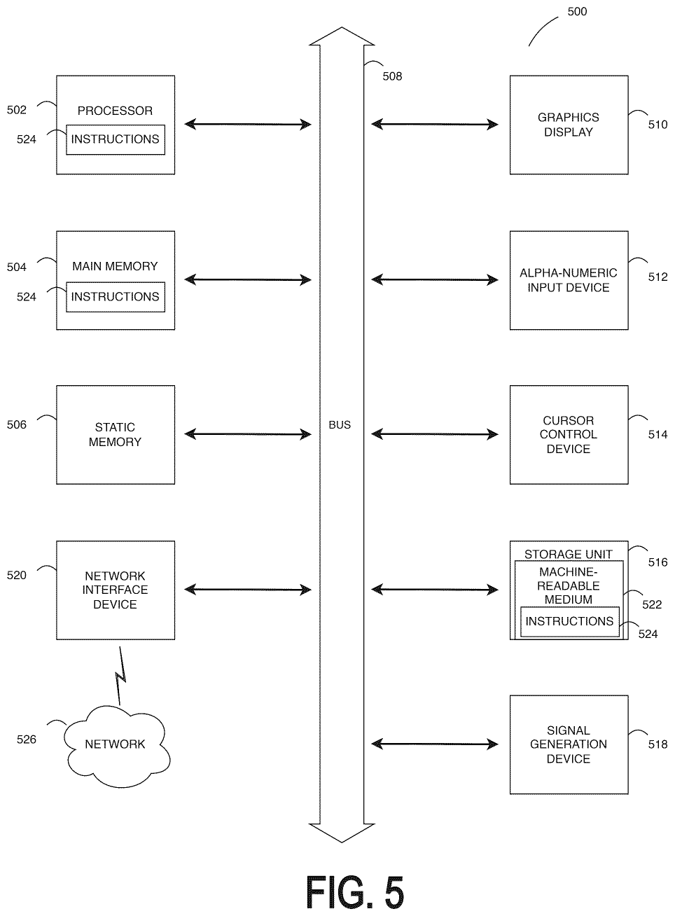

The system uses device(s) that may be a computer system, for example, having some or all of the components of the computer system described with FIG. 5. For example, the computing device may be a desktop computer, a laptop computer, a tablet computer, a mobile device, a smartwatch, or any machine capable of executing instructions. The computing device is configured to communicate via a network such as via the internet, via BLUETOOTH, or between components or processes on the same computer system.

FIG. 5 is a block diagram illustrating components of an example machine able to read instructions from a machine-readable medium and execute them in a processor (or controller).

Specifically, FIG. 5 shows a diagrammatic representation of a machine in the example form of a computer system 500. The computer system 500 can be used to execute instructions 524 (e.g., program code or software) for causing the machine to perform any one or more of the methodologies (or processes) described herein, including those associated, and described, with the components (or modules) of the system 600 (as shown in FIG. 6), data store 606, and/or trusted execution environment 604. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 524 (sequential or otherwise) that specify actions to be taken by that machine. Further, while only a single machine is illustrated, the term “machine” shall also be taken to include any collection of machines that individually or jointly execute instructions 524 to perform any one or more of the methodologies discussed herein.

The example computer system 500 includes one or more processing units (generally one or more processors 502). The processor 502 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. Any reference herein to a processor 502 may refer to a single processor or multiple processors. The computer system 500 also includes a main memory 504. The computer system may include a storage unit 516. The processor 502, memory 504, and the storage unit 516 communicate via a bus 508.

In addition, the computer system 500 can include a static memory 506, a display driver 510 and 608 (e.g., to drive a plasma display panel (PDP), a liquid crystal display (LCD), or a projector). The computer system 500 may also include alphanumeric input device 512 (e.g., a keyboard), a cursor control device 514 (e.g., a mouse, a trackball, a joystick, a motion sensor, or other pointing instrument), a signal generation device 518 (e.g., a speaker), and a network interface device 520, which also are configured to communicate via the bus 508.

The storage unit 516 includes a machine-readable medium 522 on which is stored instructions 524 (e.g., software) embodying any one or more of the methodologies or functions described herein. The instructions 524 may also reside, completely or at least partially, within the main memory 504 or within the processor 502 (e.g., within a processor's cache memory) during execution thereof by the computer system 500, the main memory 504 and the processor 502 also constituting machine-readable media. The instructions 524 may be transmitted or received over a network 570 via the network interface device 520.

While machine-readable medium 522 is shown in an example embodiment to be a single medium, the term “machine-readable medium” should be taken to include a single medium or multiple media (e.g., a centralized or distributed database, or associated caches and servers) able to store the instructions 524. The term “machine-readable medium” shall also be taken to include any medium that is capable of storing instructions 524 for execution by the machine and that causes the machine to perform any one or more of the methodologies disclosed herein. The term “machine-readable medium” includes, but not be limited to, data repositories in the form of solid-state memories, optical media, and magnetic media.

FIG. 6 is an example embodiment of a networked computing environment in which decentralized sensitive information sharing with data may be provided. In some instances, the computing system 600 could be within a mobile phone, desktop computer, split across geographically distributed cloud environments, or any combination. An application 602 with logic represents the primary point of interaction or automation. This can represent both a secret owner and guardian. The logic may contain functions for creating the plurality or shares, reconstructing the secret from the plurality of shares, assigning shares to guardians, tracking which guardians hold shares corresponding to a particular secret, adding and removing guardian contacts, and verifying that guardians still hold the respective issued shares. The application can manage key relationships and the key material 624 facilitating encryption and integrity. In this embodiment supporting high levels of security and privacy, a Trusted Execution Environment (TEE), Secure Enclave or similar hardware security module 604 may be present to perform computation and store sensitive keys as instructed by the application logic.

The persistence of state including contact details between secret owners and guardians, guardians holding shares for respective secrets, the status of the guardians' possession of those shares, and as a guardian, the storing of the issued shares are handled through a data store 606. In one embodiment the items entered and retrieved from storage may be encrypted/decrypted.

The application may perform background processing as well as visual interaction for the secret owner or guardian, such input/output instruction that may be facilitated through a display 608 such as a touch screen. Alternately, other embodiments may use a monitor, keyboard, and mouse.

The communication component 610 enables the application to communication with other computing systems which may occur via network 626 such as software defined, wired, Wi-Fi, Bluetooth 628, or any other medium of communication. An alternate embodiment could use the display to present data such as via a QR code and camera to read data as the communication medium. The communication to other computing systems is a presentation of communication between the secret owner and guardians. Examples of some computing systems could be mobile devices 650, desktop computers 652, or virtual cloud or physical servers 654.

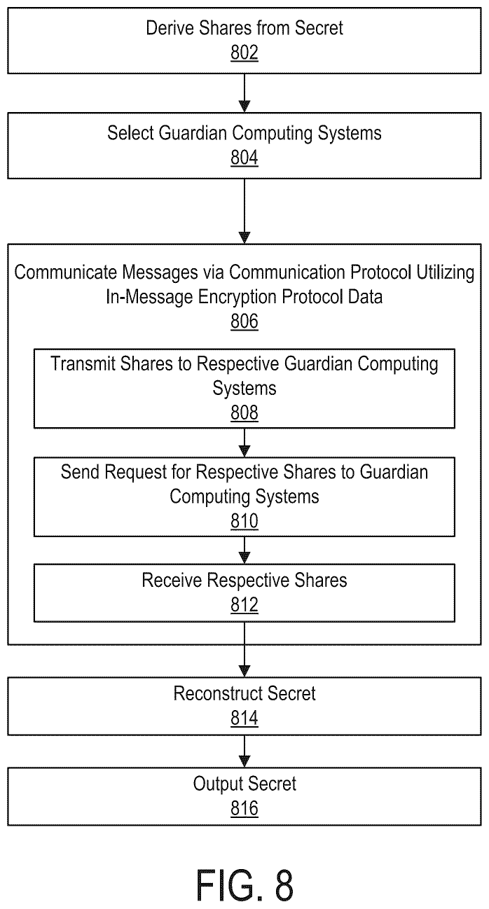

FIG. 8 is an example embodiment of a method for managing a secret according to the principles described herein. In some instances, the secret may comprise encrypted content, but in other instances the secret may be embodied as any machine-readable data. At a secret owner's computing system (which may comprise any type of computing device or system such as those described herein), a plurality of shares are derived 802 from a secret such that the secret is reconstructable from at least a quorum number of the plurality of shares. For example, in some embodiments, deriving the plurality of shares comprises applying a Shamir's secret sharing, Blakely's secret sharing, or Closest Vector Theorem-based secret sharing algorithm. In some embodiments, deriving the plurality of shares of the secret comprises performing size randomization of the plurality of shares such that sizes of the shares lack correspondence to a size the secret (so the size in bytes does not correspond to the size of the secret), and storing a randomized identifier at the secret owner's computing device identifying the size randomization.

A set of guardian computing systems (which may comprise any type of computing device or system such as those described herein) are selected 804 for storing the plurality of shares in a decentralized manner. In an example embodiment, the set of guardian computing systems are selected by accessing a contact list associated with the secret owner's computing system, and selecting the set of guardian computing systems from the contact list. However, in other embodiments, the set of guardian computing systems may be selected in a different manner.

Messages are communicated 806 via a communication protocol with each of the set of guardian computing systems. At least some of the messages include encryption protocol data that operates to coordinate key updates for securing subsequently transmitted messages between the secret owner's computing system and the respective guardian computing systems. In some embodiments, the encryption protocol data in at least some of the messages operates to coordinate the key updates by performing a key rotation derived from a prior key. In other embodiments, the encryption protocol data in at least some of the messages may operate to coordinate the key updates by generating a unique new key without correlation to any prior key. In some embodiments, the encryption protocol data in at least some of the messages may further operate to coordinate initial key negotiations for securing subsequently transmitted messages between the secret owner's computing system and the respective guardian's computing systems. In some embodiments, communicating the messages comprises establishing a process-to-process level encryption using a Double Ratchet, Diffie-Hellman, ML-KEM, Classic McEliece, HQC, BIKE, or Post-Quantum Extended Diffie-Hellman algorithm.

When communicating the messages, one of the plurality of shares from the secret owner's computing system is transmitted 808 to the guardian computing system in secured form in accordance with the communication protocol. In some embodiments, the set of guardian computing systems store their respective shares in encrypted form. The message communications may also include obtaining a request for reconstruction of the secret, and responsive to the request, sending 810 respective requests for respective shares to at least a subset of the set of guardian computing systems. Here, the subset comprises at least the quorum number. Using the communication protocol, at least a subset of the plurality of shares are received 812 from at least the subset of guardian computing systems. The subset of the plurality of shares comprises at least the quorum number. The secret is reconstructed 814 from the subset of the plurality of shares. In an embodiment, reconstructing the secret comprises reconstructing an encrypted version of the secret from the shares, decrypting the encryption version of the secret to reveal the secret. The secret is then outputted 816 (e.g., for viewing or storing on the secret owner's computing system).

In some embodiments, while the set of guardian computing systems are holding the shares, the secret owner's computing system may receive an alert indicating that a guardian computing system no longer holds its respective share. The respective share may then be redistributed to a different guardian computing system. In some embodiments, the secret owner's computing system may furthermore detect that a guardian computing system fails to meet a status condition associated with maintaining its share. Responsive to the guardian computing system failing to meet the status condition, the secret owner's computing system may cause removal of the share from the guardian computing system.

In some embodiments, the secret owner's computing system may furthermore facilitate a verification process in which it communicates with at least one of the set of guardian computing systems to verify possession of its share.

### Additional Considerations

Some real-world implementations have a known set of participants that are used across multiple secrets and often require a normal or equal distribution of shares across those participants. Such a design reduces operating complexity while enabling optimizations for a fit-for-purpose offering. Conversely, this introduces risk in that the known set of participants can collude, the known set of participants become an attack target, and the flexibility in distribution is limited to at most, that of the set.

In the disclosed embodiments, such a limitation is not necessary for real-world application. Instead, the disclosed embodiments enable a secret holder to pick their own set of guardian participants and to assign shares at a distribution of the secret holder's choosing. This set is per secret such that a secret holder can optionally apply a unique guardian participant set and unique share distribution per secret.

Data quantity or data size as a measure in Bytes, KB, MB, GB, is often a limitation in real-world solutions. For example, one solution takes a secret and generates a printable QR code for each share. Another similar solution uses rapidly changing QR codes to allow for more data than can reasonably be stored and shared in a single printable QR code. These solutions are meant to empower the secret holder to select their guardian participants. This has the additional benefit that the guardian participants do not need to know about each other or the threshold required for recovery. However, the following limitations apply:
the distribution and collection medium may inhibit security.
the data may be stolen.
there is no reliable way to confirm the guardian participant is still in possession of the shares.
the size of the data is highly restrictive.

Sometimes, such solutions instruct users to encrypt the data with an encryption key and then only use the secret sharing for the key. While doing so holds an additional risk that the data itself could be lost or a target for a brute force attack, at times it may be the only practical solution.

The disclosed embodiments address all those limitations as described within. While the disclosed embodiments do not prevent such an approach for dealing with larger data, it does not require it either. When it comes to the data, the automation of using the utility functions described within allows for all the data to be split into shares and decentralized with the ability to reconstruct the data by meeting the consensus threshold.

Embodiments of the described computing environment and corresponding processes may be implemented by one or more computing systems. The one or more computing systems include at least one processor and a non-transitory computer-readable storage medium storing instructions executable by the at least one processor for carrying out the processes and functions described herein. The computing system may include distributed network-based computing systems in which functions described herein are not necessarily executed on a single physical device. For example, some implementations may utilize cloud processing and storage technologies, virtual machines, or other technologies.

The foregoing description of the embodiments has been presented for the purpose of illustration; it is not intended to be exhaustive or to limit the embodiments to the precise forms disclosed. Persons skilled in the relevant art can appreciate that many modifications and variations are possible in light of the above disclosure. It is therefore intended that the scope is not limited by this detailed description, but rather by any claims that issue on an application based hereon. Accordingly, the disclosure of the embodiments is intended to be illustrative, but not limiting, of the scope of the invention.

What is claimed is:

1. A method for managing a secret embodied as machine-readable data in a decentralized computer environment, the method comprising:
at a secret owner's computing system, deriving a plurality of shares from a secret such that the secret is reconstructable from at least a quorum number of the plurality of shares;
selecting, a set of guardian computing systems for storing the plurality of shares in a decentralized manner;
communicating messages via a communication protocol with each of the set of guardian computing systems, wherein at least some of the messages include encryption protocol data that operates to coordinate key updates for securing subsequently transmitted messages between the secret owner's computing system and the respective guardian computing systems, wherein, communicating the messages includes:
transmitting one of the plurality of shares from the secret owner's computing system to the guardian computing system in secured form in accordance with the communication protocol;
responsive to a request for reconstruction of the secret, sending respective requests for respective shares to at least a subset of the set of guardian computing systems, wherein the subset comprises at least the quorum number;
receiving, using the communication protocol, at least a subset of the plurality of shares from at least the subset of guardian computing systems, wherein the subset of the plurality of shares comprises at least the quorum number;
reconstructing the secret from the subset of the plurality of shares; and
outputting the secret.

2. The method of claim 1, wherein the encryption protocol data in at least some of the messages further operates to coordinate initial key negotiations for securing subsequently transmitted messages between the secret owner's computing system and the respective guardian's computing systems.

3. The method of claim 1, wherein the encryption protocol data in at least some of the messages operate to coordinate the key updates by performing a key rotation derived from a prior key.

4. The method of claim 1, wherein the encryption protocol data in at least some of the messages operate to coordinate the key updates by generating a unique new key without correlation to any prior key.

5. The method of claim 1, wherein deriving the plurality of shares of the secret comprises:
performing size randomization of the plurality of shares such that sizes of the shares lack correspondence to a size the secret; and
storing a randomized identifier at the secret owner's computing device identifying the size randomization.

6. The method of claim 1, further comprising:
detecting that a guardian computing system fails to meet a status condition associated with maintaining its share; and
responsive to the guardian computing system failing to meet the status condition, causing removal of its share from the guardian computing system.

7. The method of claim 1, further comprising:
performing verification by communicating with at least one of the set of guardian computing systems to verify possession of its share.

8. The method of claim 1, wherein selecting the set of guardian computing systems comprises:
accessing a contact list associated with the secret owner's computing system; and
selecting the set of guardian computing systems from the contact list.

9. The method of claim 1, further comprising:
receiving, at the secret owner's computing system, an alert indicating that a guardian computing system no longer holds its respective share; and
redistributing the respective share to a different guardian computing system.

10. The method of claim 1, wherein deriving the plurality of shares comprises applying a Shamir's secret sharing, Blakely's secret sharing, or Closest Vector Theorem-based secret sharing algorithm.

11. The method of claim 1, wherein the secret comprises encrypted content prior to deriving the shares.

12. The method of claim 1, wherein communicating the messages comprises establishing a process-to-process level encryption using a Double Ratchet, Diffie-Hellman, ML-KEM, Classic McEliece, HQC, BIKE, or Post-Quantum Extended Diffie-Hellman algorithm.

13. The method of claim 1, wherein the set of guardian computing systems store their respective shares in encrypted form.

14. The method of claim 1, wherein reconstructing the secret comprises:
reconstructing an encrypted version of the secret from the shares; and
decrypting the encryption version of the secret to reveal the secret.

15. A non-transitory computer readable storage medium storing instructions for managing a secret embodied as machine-readable data in a decentralized computer environment, the instructions executable by one or more processors for performing steps including:
at a secret owner's computing system, deriving a plurality of shares from a secret such that the secret is reconstructable from at least a quorum number of the plurality of shares;
selecting, a set of guardian computing systems for storing the plurality of shares in a decentralized manner;
communicating messages via a communication protocol with each of the set of guardian computing systems, wherein at least some of the messages include encryption protocol data that operates to coordinate key updates for securing subsequently transmitted messages between the secret owner's computing system and the respective guardian computing systems,
wherein, communicating the messages includes:
transmitting one of the plurality of shares from the secret owner's computing system to the guardian computing system in secured form in accordance with the communication protocol;
responsive to a request for reconstruction of the secret, sending respective requests for respective shares to at least a subset of the set of guardian computing systems, wherein the subset comprises at least the quorum number;
receiving, using the communication protocol, at least a subset of the plurality of shares from at least the subset of guardian computing systems, wherein the subset of the plurality of shares comprises at least the quorum number;
reconstructing the secret from the subset of the plurality of shares; and
outputting the secret.

16. The non-transitory computer readable storage medium of claim 15, wherein the encryption protocol data in at least some of the messages further operates to coordinate initial key negotiations for securing subsequently transmitted messages between the secret owner's computing system and the respective guardian computing systems.

17. The non-transitory computer readable storage medium of claim 15, wherein the encryption protocol data in at least some of the messages operate to coordinate the key updates by performing a key rotation derived from a prior key.

18. The non-transitory computer readable storage medium of claim 15, wherein the encryption protocol data in at least some of the messages operate to coordinate the key updates by generating a unique new key without correlation to any prior key.

19. The non-transitory computer readable storage medium of claim 15, wherein deriving the plurality of shares of the secret comprises:
performing size randomization of the plurality of shares such that sizes of the shares lack correspondence to a size the secret; and
storing a randomized identifier at the secret owner's computing system identifying the size randomization.

20. A computer system for managing a secret embodied as machine-readable data in a decentralized computer environment, the computing system comprising:
one or more processors; and
a non-transitory computer readable storage medium storing instructions executable by one or more processors for performing steps comprising:
at a secret owner's computing system, deriving a plurality of shares from a secret such that the secret is reconstructable from at least a quorum number of the plurality of shares;
selecting, a set of guardian computing systems for storing the plurality of shares in a decentralized manner;
communicating messages via a communication protocol with each of the set of guardian computing systems, wherein at least some of the messages include encryption protocol data that operates to coordinate key updates for securing subsequently transmitted messages between the secret owner's computing system and the respective guardian computing systems,
wherein, communicating the messages includes:
transmitting one of the plurality of shares from the secret owner's computing system to the guardian computing system in secured form in accordance with the communication protocol;
responsive to a request for reconstruction of the secret, sending respective requests for respective shares to at least a subset of the set of guardian computing systems, wherein the subset comprises at least the quorum number;
receiving, using the communication protocol, at least a subset of the plurality of shares from at least the subset of guardian computing systems, wherein the subset of the plurality of shares comprises at least the quorum number;
reconstructing the secret from the subset of the plurality of shares; and
outputting the secret.
